(19) United States
(12) Patent Application Publication
(10) Pub. No.: US 2011/0089839 A1
(43) Pub. Date: Apr. 21, 2011

(54) System and method of indoor solar illumination

(76) Inventor: Chung-Chia Chen, La Habra Heights, CA (US)

(21) Appl. No.: 12/603,503

(22) Filed: Oct. 21, 2009

(51) Int. Cl. H05B 37/02; F21L 4/08

(52) U.S. Cl. 315/149; 362/183

(57) ABSTRACT

A system and method especially of using solar electricity for indoor illumination utilizes solar energy generated electricity in solar panel which installed indoor side of window, door of building and the electricity generated stored and connected to the indoor illumination device disclosed. The system consisting of at least one solar panel, storage means (battery), an electric switch, a light-sensitive resistor and at least an illumination device (lighting fixture). The electric switch and light-sensitive resistor enables or disables the electrical connection between the battery and the illumination device depending on the degree of brightness/darkness indoor as needed.

### BACKGROUND OF INVENTION

1. Field of the Invention

The present invention generally relates to use solar generated electricity for indoor illumination. More specifically, the invention is directed to a solar panel installed at the indoor side, or outdoor side of window, door of building to generate electricity and stored in rechargeable battery to be used by indoor illumination device.

2. Background of the Invention

Solar powered lights have been used for various purposes and particularly for outdoor lights on sidewalks, patios, lawns and the like. In an effort to eliminate the need for dependence on a conventional electrical utility power supply, applicant's have invented this indoor solar illumination system using the solar light collected and stored in battery to be used in the night time and this has proven successful.

The solar panel described in this system can be adhered on the indoor side glass of window, door of building to collect solar energy and produce solar electricity to be stored in electricity storage device (battery). The battery, electric switch and light-sensitive resistor can be designed to be coupled with illumination device to control the lighting of the indoor space.

As a further improvement, the present invention has as its object that of providing for the first time known in the state of the art an indoor solar illumination utilizes the solar light as a source of electric energy with solar panel installed at window, door of building.

Other objects will become apparent as the description proceeds.

### SUMMARY OF THE INVENTION

In accordance with the invention, applicant provides an indoor solar illumination system of broad application but designed primarily for illuminating a space in the building with solar panel adhered on the indoor side glass of window, door of building. An electrical wire is to connect the solar panel to the battery for storing the solar electricity. Solar electricity then illuminates the indoor illumination device through an electrical switch and a light-sensitive resistor.

A light-emitting diode (LED) cluster illumination device will be used but not limited in this patent due to the high efficient luminous property. Incandescent illumination device can be used as well.

The need for an electrical utility or fuel supply for the illumination device has thus been eliminated and a relatively inexpensive, relatively long-life, self-contained and compact solar powered indoor illumination device has been achieved all of which is believed to represent a significant advance in the art.

### BRIEF DESCRIPTION OF THE DRAWINGS

FIG. 1 is a flow sheet of the present invention.

FIG. 2 is a schematic diagram showing circuit diagram of the present invention.

FIG. 3 is a schematic view showing one embodiment of the present invention.

FIG. 4 is a schematic cross section view showing the embodiment of the present invention.

### DETAILED DESCRIPTION OF THE INVENTION

In order to further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

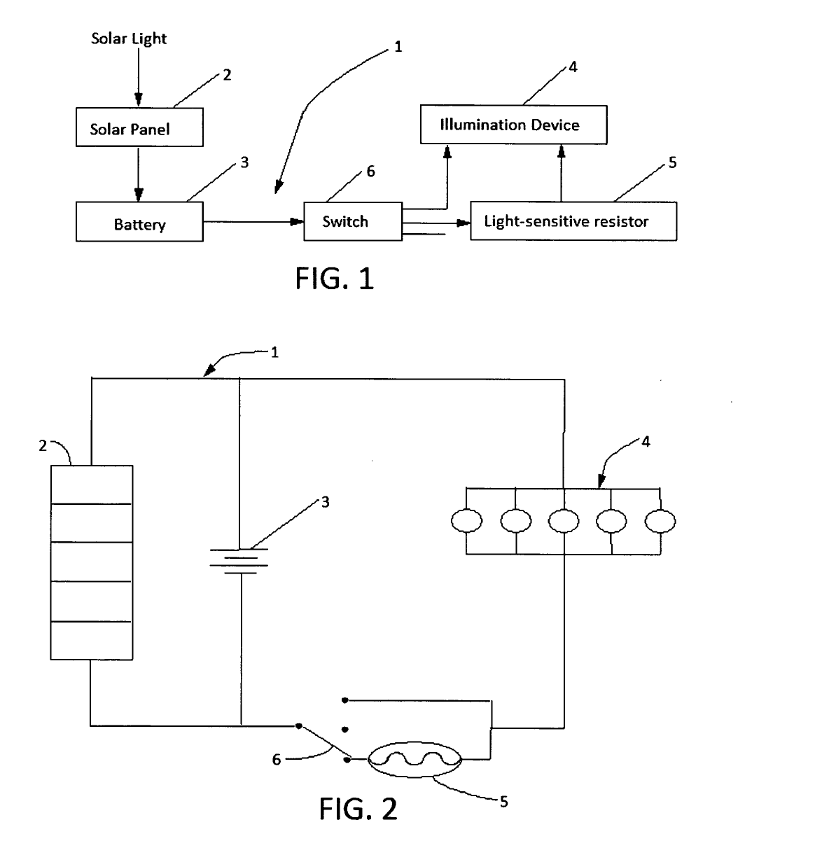

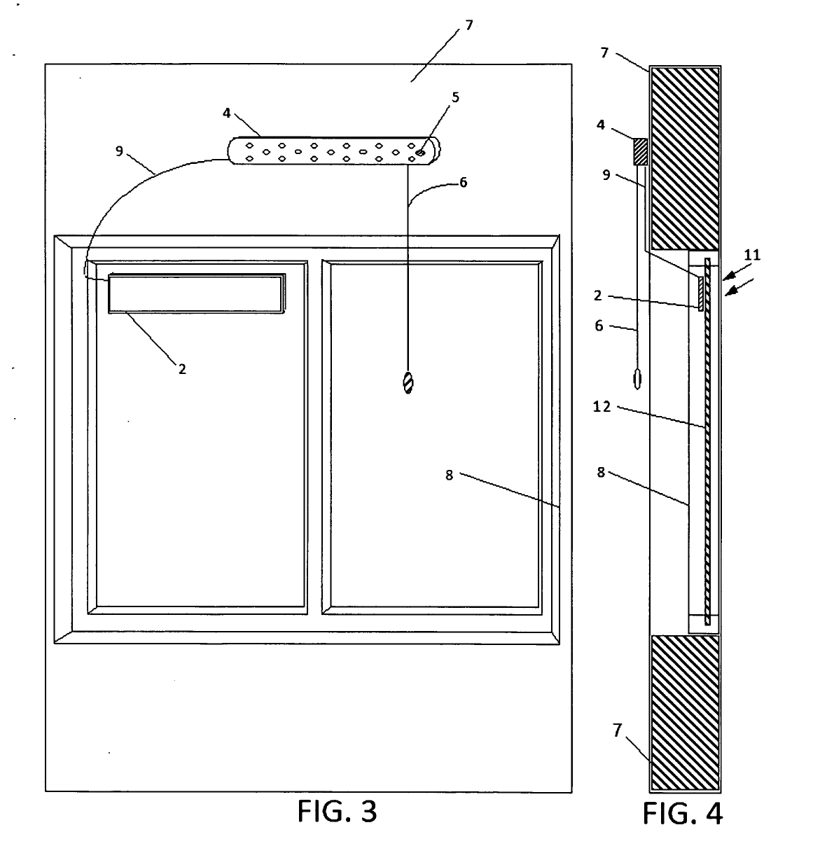

Referring to FIGS. 1, 2, 3 and 4, the structure of the present invention is illustrated. The present invention has the following elements.

An indoor solar illumination system (1) has a predetermined design which may be one of an indoor LED lamp, a lighting lamp, an indoor security light, an announcement board, a display board, etc.

The indoor solar illumination system (1) includes a solar panel (2), a battery (3), a light-sensitive resistor (5), a electric switch (6) and a illumination device (4). In this description an LED light lamp (4) is used but not limited. The solar panel (2) is adhered on the indoor side glass (12) or adhered on the frame of window (8) or door of any building (7) for receiving solar energy (11) to convert the energy into electric energy. The solar electricity then transfer through an electric wire (9) and stored in battery (3). One end of the battery (3) is connected to the electric switch (6) and the light-sensitive resistor (5). Another end of the electric switch (6) is connected to the illumination device (4). The illumination device (LED lamp set) (4) is then illuminated depending on the degree of brightness/darkness indoor. FIG. 4 shows the cross section view of the invention.

In use, with reference to FIGS. 1, 2, 3, and 4, in the indoor solar illumination system (1), the solar panel (2) receives electric energy which is converted from solar energy (11) or light energy. Then the electric energy is stored in the battery (3) which is contained in illumination device (4). When it is desired to make the light-sensitive resistor (5) to control the illumination device or LED lamp set (4), the electric switch (6) is switched to the light-sensitive resistor (5). Then the light-sensitive resistor (5) serves to actuate the LED lamp set (4). That is, by the property of the light-sensitive resistor (5), the present invention is sensitive to light. When in the weak light state, the LED lamp set (4) is light up. On the contrary, when light is sufficient as in the daytime, the power source is closed. Thus the power source is controlled automatically. Besides, when it is desired to make the electric switch (6) not controlled by the light-sensitive resistor (5), the LED lamp set (4) will light up or turn off manually depends on the need of the indoor light condition. Thus the user can control the state as desired.

Therefore, in the present invention, the solar panel (2) serves to convert the solar energy (11) into electric energy and then store the electric energy into the battery (3). The light-sensitive resistor (5) is used as an auto-control device of the electric switch (6). Not only the power can be supplied by itself and no external power source is necessary. The light-sensitive resistor (5) serves to control the power up of the device. The light-sensitive resistor (5) lights up in weak light state. Thus the power is saved.

Furthermore by the indoor solar illumination system (1) of the present invention, in night, the self-light-up LED lamp (4) of the present invention will light up as an LED lamp, a light lamp, an indoor security light, an announcement board, a display board, etc; so as to save energy.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

The invention claimed is:

1. System and method of indoor solar illumination, comprising: at least one solar panel (2); at least one battery (3); an electric switch (6); a light-sensitive resistor (5); and at least one indoor illumination device (4).

2. The said solar panel (2) with any shape or design is suitable for directly providing collected electricity to storage means (battery) (3).

3. The battery (3) is a rechargeable battery.

4. The battery (3) is a nickel-metal hydride battery.

5. The battery (3) is a cadmium battery.

6. The electric switch (6) is 3-way electrical switch to control the electricity to the illumination device (4).

7. The light-sensitive resistor (5) or photo resistor (5) enables or disables the illumination device (4) depending on the degree of brightness/darkness indoor as needed.

8. The illumination device (4) can be an LED (Light-Emitting Diode) lighting lamp with any shape or design.

9. The illumination device (4) can be a fluorescent illumination lamp with any shape or design.

10. The illumination device (4) can be a halogen illumination lamp with any shape or design.

11. The illumination device (4) can be an incandescent illumination lamp with any shape or design.
